(19) United States
(12) Patent Application Publication
(10) Pub. No.: US 2022/0184949 A1
(43) Pub. Date: Jun. 16, 2022

(54) FLUID EJECTION FACE SELECTIVE COATING

(71) Applicant: Hewlett-Packard Development Company, L.P., Spring, TX (US)

(72) Inventors: Chien-Hua Chen, Corvallis, OR (US); Michael G. Groh, Corvallis, OR (US)

(73) Assignee: Hewlett-Packard Development Company, L.P., Spring, TX (US)

(21) Appl. No.: 17/414,216

(22) PCT Filed: Sep. 6, 2019
(86) PCT No.: PCT/US2019/050034

§ 371 Date: Jun. 15, 2021

(51) Int. Cl. B41J 2/14

(52) U.S. Cl. CPC B41J 2/1433

(57) ABSTRACT

A fluid ejection head may include a fluid ejection face through which fluid ejection orifices extend. A coating is selectively coated over first portions of the fluid ejection face. Second portions of the fluid ejection face omit the coating.

### BACKGROUND

Fluid ejection heads selectively eject droplets of fluid through orifices in a fluid ejection face. Such fluid ejection heads may be part of a printer which selectively deposits droplets of fluid, such as in the form of ink, upon a print medium. Prior to use of the fluid ejection head, the fluid ejection face may be covered with shipping tape.

### BRIEF DESCRIPTION OF THE DRAWINGS

FIG. 1 is a block diagram schematically illustrating portions of an example fluid ejection head.

FIG. 2 is a flow diagram illustrating an example fluid ejection head treatment method.

FIG. 3 is a block diagram schematically illustrating portions of an example fluid ejection head.

FIG. 4A is a bottom view illustrating portions of an example fluid ejection head.

FIG. 4B is a sectional view of the fluid ejection head of FIG. 4A taken along line 4B-4B.

FIG. 4C is a sectional view of the fluid ejection head of FIG. 4A taken along line 4C-4C.

FIG. 5 is a bottom view illustrating portions of an example fluid ejection head.

FIG. 6 is a bottom view illustrating portions of an example fluid ejection head.

FIG. 7 is a bottom view illustrating portions of an example fluid ejection head receiving fluid from fluid supplies.

FIG. 8A is a top view schematically illustrate portions of an example fluid ejection system.

FIG. 8B is a side view schematically illustrating portions of the example fluid ejection system of FIG. 8A with an example fluid ejection head positioned opposite an example purging and wiping station of an example fluid ejection head service station.

FIG. 8C is a top view of the example fluid ejection system with the example fluid ejection head positioned opposite to an example selective coating station of the example fluid ejection head service station.

FIG. 8D is a side view schematically illustrating portions of the example fluid ejection system of FIG. 8C during coating of an example web with a non-wetting layer of controlled thickness.

FIG. 8E is a side view illustrating portions of the example fluid ejection system of FIG. 8E during modification the web and the non-wetting layer being by an applied vacuum.

FIG. 8F is a side view schematically illustrating portions of the example fluid ejection system of FIG. 8E with an example fluid ejection face of the example fluid ejection head being stamped by the modified non-wetting layer.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Prior to use of a printhead, such as during shipping and/or storage of a printhead, the fluid ejection face of the printhead is protected and sealed by shipping tape that has an adhesive adhering the shipping tape to the ejection face of the printhead. Removal of the shipping tape may sometimes damage the ejection face, such as portions of the face about the ejection orifices.

During use of a printhead over time, the fluid ejection face and the orifices of a fluid ejection head may become contaminated or acquire an energy state (fluid philic or phobic characteristic) that may cause puddling of fluid on the fluid ejection face. Such contamination or puddling may lead to inconsistent droplet size and inconsistent fluid ejection. Such contamination or puddling may lead to poor ejection or print quality.

Disclosed are example fluid ejection heads, fluid ejection head treatment methods and fluid ejection head selective coating stations that may address the aforementioned issues pertaining to damage caused by shipping tape removal and fluid puddling on the fluid ejection face. In contrast to coating the entire surface of the fluid ejection face which may impair the ability of the shipping tape to protect and seal the ejection orifices or which may lead to the coating being deposited in the ejection orifices, the disclosed example fluid ejection heads, fluid ejection head treatment methods and fluid ejection head selective coating stations selectively coat a layer of material over selected portions of the fluid ejection face, leaving others portions of the fluid ejection face without the coating. For purposes of this disclosure, the term “selective” or its derivatives with respect to the coating of a material to portions of a fluid ejection face means the purposeful and controlled provision of the material at selected, predetermined and defined portions (less than 100%) of the fluid ejection face so as to also purposively and controllably omit the material on other remaining portions of the fluid ejection face.

Damage otherwise occurring during the removal of shipping tape may be reduced by selectively coating portions of the fluid ejection face with a coating having a lower adhesive strength as compared to the adhesives of the shipping tape. For example, edges of the fluid ejection face where damage might occur during tape removal may be coated with the lower tacky coating, while other portions of the fluid ejection face, less susceptible to shipping tape removal damage, may remain directly adhered to the more tacky shipping tape so as to maintain sealing of the fluid ejection orifices.

Fluid puddling along the ejection face may be reduced by selectively coating particular portions of the fluid ejection head with a coating of a wetting and/or non-wetting material. For example, regions adjacent to and about the fluid ejection orifices may be coated with a non-wetting material which repels fluid on the fluid ejection face away from the fluid ejection orifices. Other regions of the fluid ejection face may be coated with a wetting material which may tend to spread any fluid on the fluid ejection face to reduce such puddling. As a result, fluid ejection performance may be enhanced.

In some implementations, the fluid ejection face of the fluid ejection head is selectively coated with materials to reduce fluid puddling prior to use of the fluid ejection head and prior to shipment of the fluid ejection head. In some implementations, the fluid ejection head may be selectively coated with a less tacky layer of material prior to application of the shipping tape. In some implementations, the fluid ejection head may be periodically retreated following the initial use of the fluid ejection head by selectively coating materials on the fluid ejection face to reduce fluid puddling.

Disclosed is an example fluid ejection head. The example fluid ejection head may comprise a fluid ejection face through which fluid ejection orifices extend. A coating is selectively coated over first portions of the fluid ejection face. Second portions of the fluid ejection face omit the coating.

Disclosed is an example fluid ejection head treatment method. The method may comprise selectively applying a coating to first portions a fluid ejection face of a fluid ejection head. The method further comprises selectively omitting the coating from second portions of the fluid ejection face.

Disclosed is an example fluid ejection head treatment system. The system may comprise a film, a vacuum chuck, an applicator, a vacuum source and an actuator. The vacuum chuck comprises raised portions and depressed portions. The depressed portions correspond to portions of the fluid ejection face which are not to be selectively coated by the system. The applicator is to apply coating to the film. The vacuum source is connected to the vacuum chuck to draw first portions of the film, coated with the coating, into the depressed portions. The actuator is to move a fluid ejection head and/or the vacuum chuck into proximity so as to transfer the coating onto a fluid ejection face of the fluid ejection head.

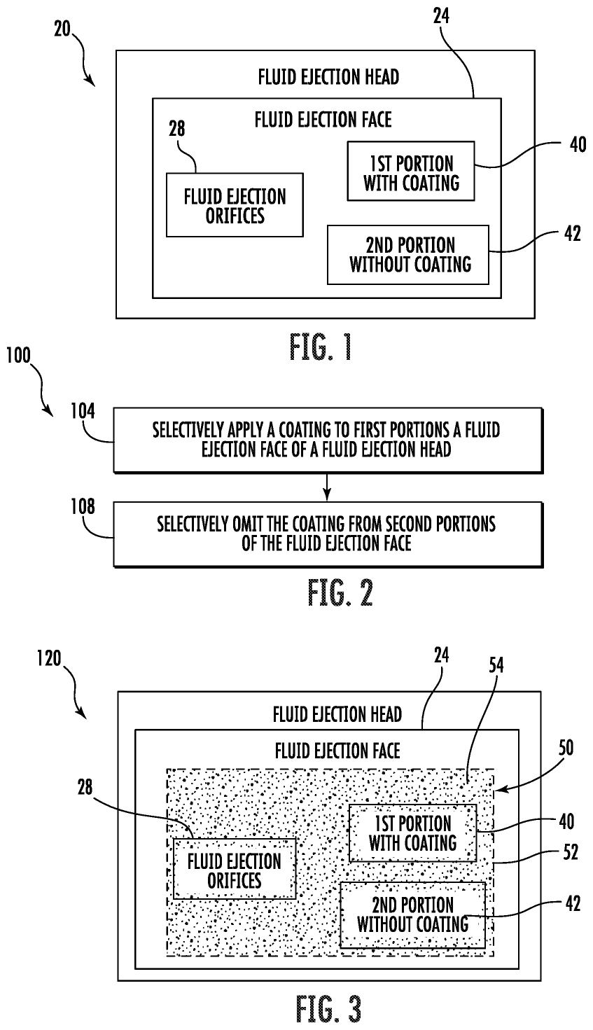

FIG. 1 is a block diagram schematically illustrating portions of an example fluid ejection head 20. Fluid ejection head 20 comprises a fluid ejection face 24 through which fluid ejection orifices 28 extend for the ejection of fluid. Such orifices may be arranged in rows or columns. Such orifices may direct the ejection of a single characteristic fluid or different fluids having different characteristics such as different chemical compositions, different colors and the like. Such orifices may facilitate the ejection of fluid being displaced by a fluid actuator disposed within the fluid ejection head 20. The fluid actuator may comprise a thermal resistor fluid actuator or may comprise other forms of fluid actuators for displacing fluid within an ejection chamber through a corresponding ejection orifice.

As further schematically shown by FIG. 1, the fluid ejection face comprises a first surface portion 40 that is provided with a coating and a second surface portion 42 that omits the coating. The first and second surface portions 40 and 42 are schematically illustrated as blocks so as to not be limited to any particular location along face 24, shape, pattern, size, proportionality with respect to one another or any particular number of individual spaced regions forming either portion 40 or portion 42. The first and second surface portions 40, 42 of the fluid ejection face 24 comprise surface portions that generally face the media or other receptacle that is to receive the fluid being ejected through fluid ejection orifices 28. The first and second surface portions 40, 42 of the fluid ejection face 24 do not include the openings along the fluid ejection face that form the fluid ejection orifices 28. In other words, the orifices themselves do not constitute the second surface portions which omit the coating.

In one implementation, the first portion 40 with the coating may extend around or about the fluid ejection orifices 28. In one implementation, the first portion 40 with the coating may extend along opposing edges of the fluid ejection face 24 or along all of the edges of the fluid ejection face 24. In one implementation, the first portion 40 with the coating may extend directly adjacent to and around each of the fluid ejection orifices 28. In yet another implementation, the first portion 40 with the coating may be spaced from each of the fluid ejection orifices by a predetermined extent. In one implementation, the coating may continuously extend around an uncoated portion of the fluid ejection face 24. In some implementations, the first portion 40 with the coating may be applied in various patterns in selected portions or across fluid ejection face 24. For example, in some implementations, the first portion 40 with the coating may deposited or applied as stripes, spots or other patterns on fluid ejection face 24.

As discussed above, the coating selectively applied to the first portion and not applied to the second portion may be a coating of material that has a lower tackiness or adhesive strength as compared to the adhesives of the shipping tape to reduce the likelihood of damage to the fluid ejection face during removal of the shipping tape. The coating selectively applied to the first portion and not applied to the second portion may be a coating of material having a selected fluid-philic (high surface energy) or fluid phobic characteristic (low surface energy) that is different from such characteristics for those portions of fluid ejection face not provided with the coating, wherein the coating is applied so as to reduce fluid puddling along the fluid ejection face.

FIG. 2 is a flow diagram of an example fluid ejection head treatment method 100. Although method 100 is described in the context of forming fluid ejection head 20, it should be appreciated that method 100 may likewise be utilized to treat any of the following described fluid ejection heads described hereafter or similar fluid ejection heads. It should also be appreciated that method 100 may be utilized at various times, such as during the manufacture or shipping of the fluid ejection head, prior to initial use of the fluid ejection head or periodically during life of the fluid ejection head following its initial use.

As indicated by block 104, a first portion 40 of the fluid ejection face 24 of a fluid ejection head 20 may be selectively coated with a coating. In one implementation, the fluid ejection face 24 is selectively coated by stamping a layer of the coating material onto the selected portions of fluid ejection face 24. In such an implementation, a layer or film of fluid coating is selectively formed or patterned upon selected portions of a stamping surface, wherein the fluid ejection face and/or the stamping surface are moved towards one another in directions perpendicular to the faces or surfaces until the fluid film contacts the fluid ejection face and adheres to the fluid ejection face. Such stamping may reduce the likelihood of the film a fluid coating being inadvertently deposited upon non-selected portions of the fluid ejection face or being inadvertently deposited within the interior sides of the fluid ejection orifices 28. In yet other implementations, the coating material may be selectively coated upon the fluid ejection face 24 in other manners. For example, the coating material may be directly printed upon the fluid ejection face 24 in the selected pattern or layout where less than the entire area of fluid ejection face 24 is coated with the coating.

As indicated by block 108, the coating applied in block 104 is not applied to second portions of the fluid ejection face such that the second portions of the fluid ejection face omit the coating. The second portions of the fluid ejection face that omits the coating are distinct from openings through the fluid ejection face that form the fluid ejection orifices. The first and second portions comprise solid imperforate portions of the fluid ejection face about fluid ejection orifices. In one implementation, the surface of the second portions remains exposed and constitutes the same material underlying the coating of the first portions. In one implementation, the surface of the second portions is selectively coated with a second different coating.

FIG. 3 is a block diagram schematically illustrating portions of an example fluid ejection head 120. Fluid ejection head 120 is similar to fluid ejection head 20 described above except that fluid ejection head 120 additionally comprises shipping tape 50. Those remaining components of fluid ejection head 120 which correspond to components of fluid ejection head 20 are numbered similarly. FIG. 3 illustrates an example of how the fluid ejection head may be selectively coated with a material to reduce potential damage to the fluid ejection face during removal of the shipping tape.

Shipping tape 50 comprises a thin film or layer 52 of material having a face coated with a layer 54 of adhesive material. In one implementation, layer 52 of shipping tape 50 comprises a polymeric film that is substantially air impermeable for sealing the fluid ejection orifices 28 of fluid ejection face 24 from contamination or air ingress. In one implementation, shipping tape 50 comprises an adhesive layer 54 sandwiched between the polymeric film forming layer 52 and fluid ejection face 24, wherein the adhesive layer 54 adhesively bonds shipping tape 50 to the surface of fluid ejection face 24. The adhesive layer 54 of shipping tape 50 has a first adhesive strength or first tackiness that is greater than the adhesive strength or tackiness of the coating applied to first portion 40.

In the illustrated example, the first portion 40 comprises those portions of fluid ejection face 24 that are coated with the lower adhesiveness or lonely tackiness material such that the subsequent peeling of the shipping tape 50 away from an off of fluid ejection face 24 is less likely to damage portions of fluid ejection face 24, such as regions of fluid ejection face 24 directly adjacent to the fluid ejection orifices 28. In one implementation, the adhesive layer 54 of shipping tape 50 has an adhesive strength of 1 Newton (N) per 20 mm or more, whereas the material of the coating applied to first portion 40 has a lesser adhesive strength. In one implementation, where the fluid ejection face 24 is formed from an epoxy photoresist material, such as SUB, the coating applied to first portion 40 has an adhesive strength of no greater than 0.1 N/20 mm.

In one implementation, the adhesive material forming the adhesive layer 54 of the shipping tape comprises a silicone, a neoprene, a urethane, or an acrylic type of adhesive, wherein the coating applied to portion 40 comprises low surface energy coating such as MD700 fluoropolymer material from Solvay. In one implementation, the thickness of the coating on coated portion 40 is sufficiently thin so as to not form a standoff that would otherwise form an empty void spacing adhesive layer 54 from uncoated portions of fluid ejection face 24. As a result, all or substantially all of the surface of fluid ejection face 24 without the coating, portion 42, is in contact with adhesive layer 54. In one implementation, coated portions 40 have a coating with a thickness of one monolayer. In one implementation, the thickness of the coating forming coated portion 40 is no greater than one-tenth the thickness of the adhesive layer 54 of shipping tape 50. In one implementation, the thickness of the coating applied to portion 40 is less than 1 μm. In one implementation the thickness of the coating applied to portion 40 is less than or equal to 50 Å, whereas the thickness of adhesive layer 54 of the shipping tape 50 has a thickness of 10 μm or greater. In other implementations, other shipping tapes with other adhesives and/or other coatings for portion 40 may be utilized.

The relative adhesive strengths of the adhesives of the shipping tape 50 as compared to the coating applied to portion 40 may vary depending upon the durability of the material forming the fluid ejection face 24, the number and size of fluid ejection orifices 28 through the fluid ejection face 24, the relative proportions and locations of the first portion 40 and the second portion 42, the sealing demands for fluid ejection face 24, the shipment or storage duration as well as the environmental conditions (temperature, humidity and the like) experienced by the fluid ejection head 20 during shipment or transportation. Likewise, the relative proportions and locations of the first portion 40 and the second portion 42 may vary depending upon the relative adhesive strengths of the shipping tape adhesive and coating of portion 40, the durability of the material forming the fluid ejection face 24, the number and size of fluid ejection orifices 28 through the fluid ejection face 24, the sealing demands for fluid ejection face 24 of head 20, the shipment or storage duration and the environmental conditions (temperature, humidity and the like) experienced by the fluid ejection head 20 during shipment or transportation.

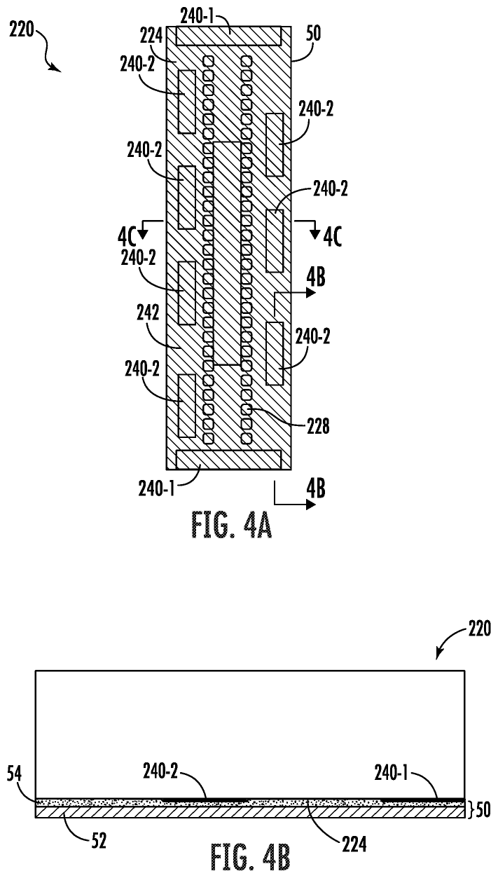

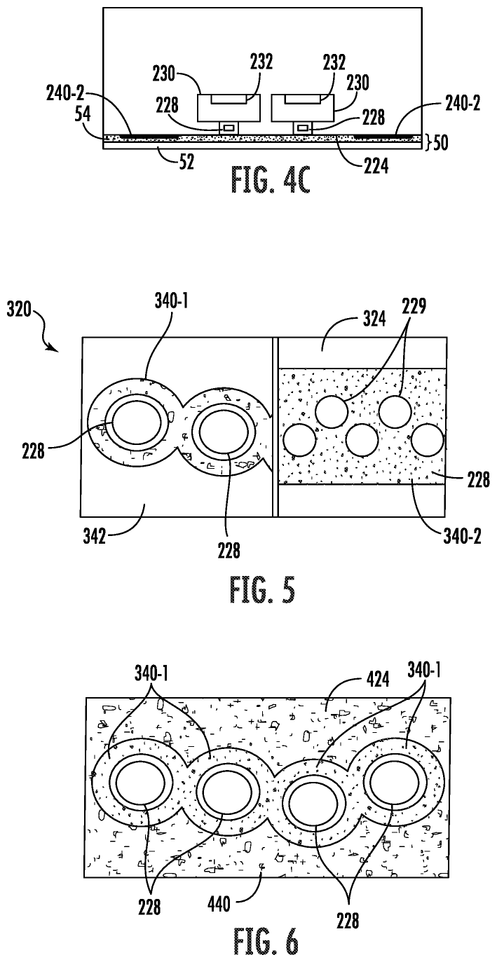

FIGS. 4A, 4B and 4C illustrate portions of an example fluid ejection head 220 having a fluid ejection face covered by a transparent shipping tape 50. FIGS. 4A, 4B and 4C illustrate an example of how a fluid ejection head may be selectively coated with a lower tackiness coating to reduce potential damage to the fluid ejection face during the removal of shipping tape. As shown by FIG. 4A, in addition to the applied shipping tape 50, fluid ejection head 220 comprises a fluid ejection face 224 comprising fluid ejection orifices 228 (of which, only one is indicated with an element number), selectively coated end portions 240-1, selectively coated side portions 240-2 (portions 240-1 and 240-2 collectively referred to as portions 240) and those remaining portions 242 that omit the coating of portions 240. For purposes of illustration, the relative thickness of the coating forming portions 240 is exaggerated.

Fluid ejection orifices 228 comprise openings through fluid ejection face 224. In the example illustrated, each of fluid ejection orifices 228 eject the same characteristic fluid, such as a fluid having the same chemical composition or a fluid, such as ink, of the same color. Fluid ejection orifices 228 are arranged in a two-dimensional array, two parallel rows along the length of face 224. In one implementation, the individual fluid ejection orifices 228 of the two rows are offset or staggered relative to one another.

As schematically shown by FIG. 4C, each of fluid ejection orifices 228 communicates with a fluid ejection chamber 230. Each fluid ejection chamber 230 comprises an internal void for containing fluid to be displaced by a fluid actuator 232 through the corresponding fluid ejection orifice 228. In one implementation, the fluid actuators 232 may each comprise a thermal resistor which, upon receiving electrical current, heats to a temperature above the nucleation temperature of the fluid so as to vaporize a portion of the adjacent fluid to create a bubble which displaces the fluid through the associated orifice 228. In other implementations, the fluid actuator may comprise other forms of fluid actuators. In other implementations, the fluid actuator may comprise a fluid actuator in the form of a piezo-membrane based actuator, an electrostatic membrane actuator, mechanical/impact driven membrane actuator, a magnetostrictive drive actuator, an electrochemical actuator, and external laser actuators (that form a bubble through boiling with a laser beam), other such microdevices, or any combination thereof.

As further shown by FIG. 4A, there may be a desire to selectively coat portions 240 of fluid ejection face 224 such that the selectively coated portions 240 have a lower adhesive strength (e.g., a lower degree of tackiness or adhesion) as compared to an adhesive layer (e.g., adhesive layer 54 in FIG. 3) of a shipping tape (e.g., shipping tape 50). Portions 240 are selectively positioned along fluid ejection face 224 to enhance the removal of shipping tape 50 and to reduce the likelihood of damage to fluid ejection face 224 or fluid ejection orifices 228 during the peeling of shipping tape 50. The lower degree of tackiness or adhesion provided by the material coated upon portions 240 facilitates peeling of shipping tape 50 away from fluid ejection face 224 in such regions with less applied force. As a result, shipping tape 50 may be more easily separated from fluid ejection face 224 prior to use of fluid ejection head 220.

In the example illustrated, portions 240 are further selectively located so as to reduce or minimize interference with the ejection of fluid through fluid ejection orifices 28. Portions 240 are selectively applied or coated upon fluid ejection face 224 to be spaced from the edges of fluid ejection orifices 228 by 2 mm or more than 2 mm. In the example illustrated, coated end portions 240-1 are located along the opposite longitudinal ends (the ends of the largest dimension of fluid ejection face 224), directly adjacent to and abutting the longitudinal edges of fluid ejection face 224. As a result, shipping tape 50 may be more easily released at such end portions during peeling in a longitudinal direction.

Coated side portions 240-2 are located at spaced locations along the opposite transverse sides of fluid ejection face 224. The spacing facilitates direct bonding between the shipping tape 50 and the uncoated portions of fluid ejection face 224 between such portions 240-2 to provide sufficient securement of shipping tape 50 and sealing of fluid ejection orifices 228. In the example illustrated, the coated side portions 240-2 on one side of fluid ejection ports 228 are offset or staggered with respect to the coated side portions 240-2 on the other side of fluid ejection ports 228. This staggering distributes the coating of portions 240-2 along a greater portion of the longitudinal length of fluid ejection face 224. In other implementations, coated side portions 240-2 may have other spacings or patterns. In other implementations, a single strip or band of the coating may continuously extend between end portions 240-1, completely encircling, without interruption, the rows of fluid ejection orifices 228. In some implementations, coated portion 240-1 may be omitted. In other implementations, coated portions 240-2 may be omitted.

As shown by FIG. 4B, in the example illustrated, shipping tape 50 is pressed against fluid ejection face 224 such that shipping tape 50 extends into direct contact (e.g., via adhesive layer 54) with the uncoated portions of fluid ejection face 224 between side coated portions 240-2. As shown by FIG. 4C, shipping tape 50 is pressed against fluid ejection face 224 such that shipping tape 50 extends into direct contact with the uncoated portions of fluid ejection face 224 (e.g., via adhesive layer 54) transversely across fluid ejection orifices 228. As a result, shipping tape 50 is directly bonded to fluid ejection face 224 in those regions adjacent to fluid ejection orifices 228 and between the coated side portions 240-2 to provide enhanced sealing of the fluid ejection orifices 228.

FIG. 5 is a bottom view illustrating portions of an example fluid ejection head 320. FIG. 5 illustrates an example of how the fluid ejection face of a fluid ejection head may be selectively coated to reduce fluid puddling along the surface of the fluid ejection face. FIG. 5 further illustrates how a fluid ejection face may be differently coated in different regions based upon the characteristics of the fluid ejection orifices. Fluid ejection head 320 comprises fluid ejection face 324, fluid ejection orifices 228 (described above), orifices 229, coated portions 340-1, 340-2 (collectively referred to as coated portions 340) and uncoated portions 342.

Orifices 229 are similar to orifices 228 except that orifices 229 have different sizes and different relative spacings or pitches as compared orifices 228. In some implementations, orifices 229 are used to eject fluid more frequently as compared orifices 228.

Coated portions 340 comprise those surfaces of fluid ejection face 324 that are coated with a film or layer of material having a surface energy selected to reduce puddling of fluid on fluid ejection face 324. In the example illustrated, coated portions 340 comprise a layer of a low surface energy material, a non-wetting material, that repels the fluid being ejected through fluid ejection orifices 228. For purposes of this disclosure, a non-wetting material comprises a material that is fluid phobic, resisting or repelling fluid. A non-wetting material is a low surface energy material that lacks attraction to a mass of the fluid that is to be ejected through the fluid ejection orifices. A non-wetting material is a material that has a contact angle of greater than 90° with respect to the fluid to be ejected through the fluid ejection orifices. In one implementation, the non-wetting material forming coated portion 340 may comprise MD700 Perfluoroether from Solvay, LT-8 fluoroacrylate from Thin Film Partners, NL272 hydrocarts/ceramic from Nasiol, NS-200 Hydropic polymer with ceramic filler from Florida CirTech, and the like. In other implementations, the non-wetting material forming coated portion 340 may comprise other low surface energy materials, such as polytetrafluoroethylene.

In the example illustrated, coated portions 340 extend in close proximity to the edges of fluid ejection orifices 228 and 229 along face 324. In one implementation, coated portions 340 are spaced no greater than 10 μm from the internal edges of orifices 228. In one implementation, coated portions 340 extend directly adjacent to the edges of orifices 228. Coated portions 340 repel the fluid being ejected away from orifices 228, 229 such that any puddling that may occur is distant from orifices 228, 229.

In the example illustrated, coated portions 340-1 and 340-2 are different. In the example illustrated, coated portion 340-1, 340-2 cover different extents and have different surface areas. In the example illustrated, coated portions 340-2, which extend about the smaller, but more closely space orifices 229, have a larger surface area or extent as compared to coated portions 340-1. In one implementation, coated portions 340-1 and 342-2 have different coating materials with different surface energies. For example, in one implementation, the coating material of coated portions 340-2 has a lower surface energy as compared to the coating material of coated portions 340-1. In other implementations, coated portions 340-1 and 340-2 are formed from the same coating material.

Uncoated portions 342 comprises those portions of fluid ejection face 324 that are not coated with the layer of material of coated portions 340. The uncoated portions 342 have a surface energy that is greater than that of coated portions 340. The uncoated portion 342 are less likely to repel the fluid being ejected through fluid ejection orifices 228 as compared to coated portion 340. In one implementation, uncoated portions 342 are formed by the material forming the interior sides of the fluid ejection orifices 228. In some implementations in which the fluid ejection head 320 comprises an integrated ejection chamber/orifice layer, the material forming the uncoated portions 342 is the same material that forms and defines the ejection chambers. In one implementation, the material forming the uncoated portion 342 of fluid ejection face 324 comprises a polymeric material, such as an epoxy. In one implementation, such material may comprise SUB.

FIG. 6 is a bottom view illustrating portions of an example fluid ejection head 420. FIG. 6 illustrates an example of how two different coatings may be each selectively applied to different portions of a fluid ejection face to reduce fluid puddling. Fluid ejection head 420 comprises fluid ejection face 424, fluid ejection orifices 228 (described above), coated portions 340 (described above) and coated portions 440

Fluid ejection face 424 is similar fluid ejection face 324, 224 and 24 in that the fluid ejection face 424 comprises those surfaces of the fluid ejection head 420 that are opposite to and face the media or other ejection target that is to receive the fluid being ejected through orifices 228. In one implementation, uncoated portions of fluid ejection face 424 may extend adjacent to the fluid ejection orifices. In one implementation, uncoated portion of the fluid ejection face 424 may comprise the photoresist epoxy such as SU8.

Coated portions 440 comprise portions of fluid ejection face 424 that include a coating of material having a surface energy greater than that of coated portions 340 and greater than that of the underlying materials of fluid ejection head 220 on which coating 440 is coated and contacts. In one implementation, the material of the coating forming coated portions 440 has a surface energy so as to be more fluid philic and wetting as compared to the underlying SU8 and forms the interior sides of ejection orifices 228 and, in some implementations, the fluid ejection chambers 230 (shown in FIG. 4C).

In the example illustrated, coated portions 440 extend across a majority of the remaining portions of fluid ejection face 424, other than coated portions 340. Coated portions 440 attract the fluid repelled by coated portions 340 and disperse or spread out the fluid across the area of coated portions 440. As a result of such spreading, the fluid is less likely to puddle and is less likely to impair fluid ejection performance.

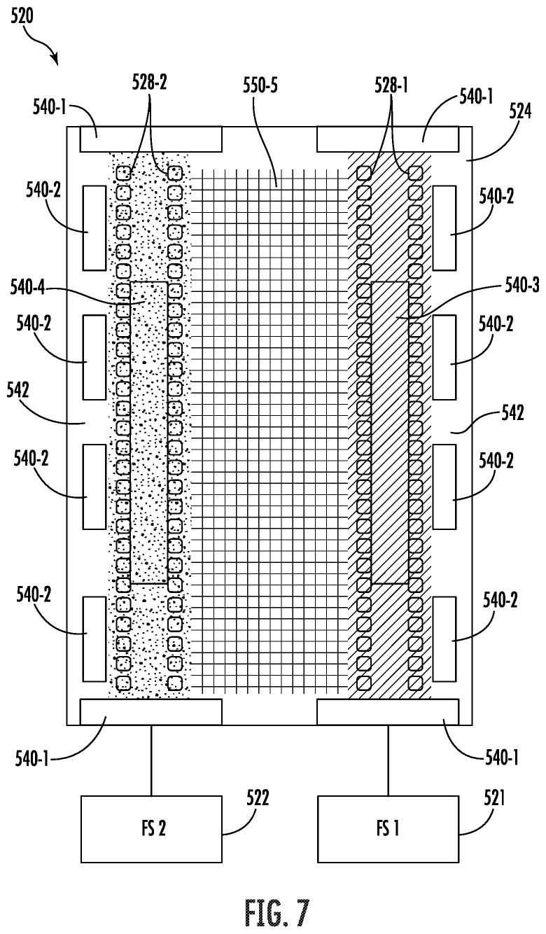

FIG. 7 is a bottom plan view illustrating portions of an example fluid ejection head 520 and associated fluid supplies 521, 522. FIG. 7 illustrates an example of how different coatings may be selectively applied to different portions of a fluid ejection face of the fluid ejection head to differently modify performance of different regions of the fluid ejection face. Fluid ejection head 520 comprises fluid ejection face 524, fluid ejection orifices 528-1, 528-2 (collectively referred to as fluid ejection orifices 528), differently coated portions 540-1, 540-2, 540-3, 540-4, 540-5 and uncoated portions 542. Fluid ejection face 524 is similar to fluid ejection face 224 described above in that fluid ejection face 524 faces the print medium or other receptacle that is to receive fluid ejected through fluid ejection orifices 528.

Fluid ejection orifices 528-1 and 528-2 each comprise a pair of parallel rows of fluid ejection orifices that extend through fluid ejection face 524. Fluid ejection orifices 528 are similar to fluid ejection orifices 228 described above except that a first fluid having a first composition, supplied by source 521, is to be ejected through fluid ejection orifices 528-1 and a second fluid having a second composition, different than the first composition, supplied by fluid source 522, is to be ejected through fluid ejection orifices 528-2. For example, in one implementation, fluid ejection orifices 528-1 are to direct ejected fluid having a first wetting characteristic while fluid ejection orifices 528-2 are to direct ejected fluid having a second wetting characteristic different than the first wetting characteristic. In one implementation, orifices 528-1 are to direct a first color of ejected ink supplied from fluid source 521 while orifices 528-2 are to direct a second color of ejected ink supplied from fluid source 522.

Coated portions 540-1 are similar to coated portions 240-1 described above. Coated portions 540-2 extend on opposite transverse sides of fluid ejection face 524 and are similar to coated portions 240-2 described above. Coated portions 540-1 and 540-2 comprise portions of fluid ejection face 524 coated with a material having lower adhesive strength or tackiness as compared to the adhesive layer 54 of shipping tape 50 (described above). Coated portions 540-1 and 540-2 facilitate the peeling or separation of shipping tape 50 from fluid ejection face 524 to reduce potential damage to portions of fluid ejection face 524 during such removal of shipping tape 50.

Coated portions 540-3 and 540-4 are each similar to coated portions 340 described above. Coated portions 540-3 and 540-4 extend about fluid ejection orifices 228 in close proximity to the edges of such orifices. Coated portions 540-3 and 540-4 comprise films or layers of material having a lower surface energy as compared to the uncoated portions 542 and the surface which directly underlies and contacts the coated portions 540-3 and 540-4. The lower surface energy of coated portions 540-3 and 540-4 cause such portions to be more fluid phobic and so as to repel fluid away from fluid ejection orifices 528 to reduce puddling of fluid on fluid ejection face 524 proximate to fluid ejection orifices 528.

In the example illustrated, coated portions 540-3 comprise a first coating material while coated portions 540-4 comprise a second coating material different than the first coating material. The different coatings may be selected based upon the different characteristics of the fluids being ejected by fluid ejection orifices 528-1 and 528-2. In some implementations where the orifices 528-1 have different sizes, shapes or relative spacings (pitch) relative to one another, the different coatings selectively applied about such different fluid ejection orifices 528-1, 528-2 may be additionally or alternatively based upon such differences. Different orifices 528 may be surrounded by different extents of the coating as compared to one another based upon their different sizes, shapes, pitches and the like. For example, in one implementation, orifices 528-1 are more closely spaced as compared orifices 528-2. In such an example, the more closely spaced orifices 528-1 may be surrounded by a different coating or may be surrounded by a coating that extends into closer proximity to the edges of the individual orifices 528-1 as compared to the orifices of 528-2.

In yet other implementations, different coatings or different surface areas of coating may be applied about different orifices based upon the usage of such orifices. For example, in one implementation, fluid is ejected more frequently through orifices 528-1 as compared to orifices 528-2. In such an implementation, different coatings may be applied about orifices 528-1 and 528-2. In yet another example, the orifices 528-1 that are more frequently used to eject fluid may be surrounded by a non-wetting material coating having a larger area, covering a larger region about each of the individual orifices 528-1.

Coated portions 550-5 are similar to coated portions 440 described above. Coated portions 550-5 comprises portions of fluid ejection face 524 that comprise a selectively applied coating of a material that has a higher surface energy (more fluid philic/less fluid phobic) as compared to coated portions 540-3, 540-4 and as compared to the uncoated portions 542 and the surface which directly underlies and contacts the coated portions 550-5. In the example illustrated, coated portions 550-5 extend between fluid ejection orifices 528-1 and fluid ejection orifices 528-2. Similar to coated portions 440, coated portions 550-5 are coated with material that wets or attracts the fluid being ejected through fluid ejection orifices 528. As a result, any fluid collecting on the surface of fluid ejection face 524 is first repelled by coated portions 540-3 and 540-4 and then attracted by coated portions 540-5 to spread the fluid into a thin film, reducing any puddling which might impair fluid ejection or printing performance.

Uncoated portions 542 are similar to uncoated portions 242 and 342 described above. Uncoated portions 542 comprise portions of fluid ejection face 524 that are not coated, wherein the surfaces of uncoated portions 542 are provided by the same material that forms the internal sides of orifices 528 and, in some implementations, fluid ejection chambers 230 (described above). In one implementation, uncoated portions 542 are formed from materials such as a photoresist epoxy, for example SU8.

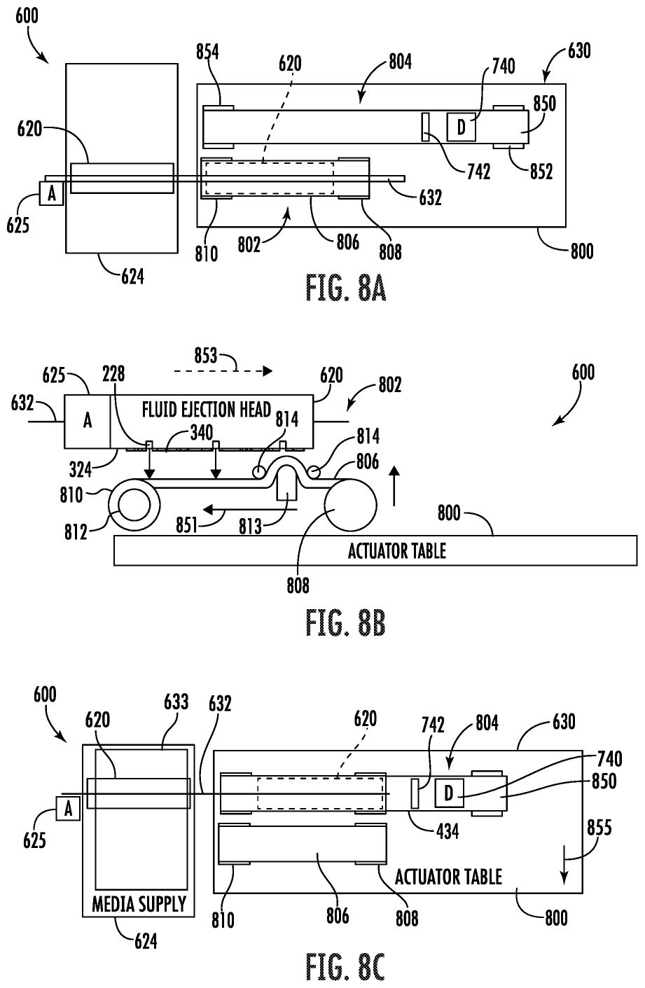

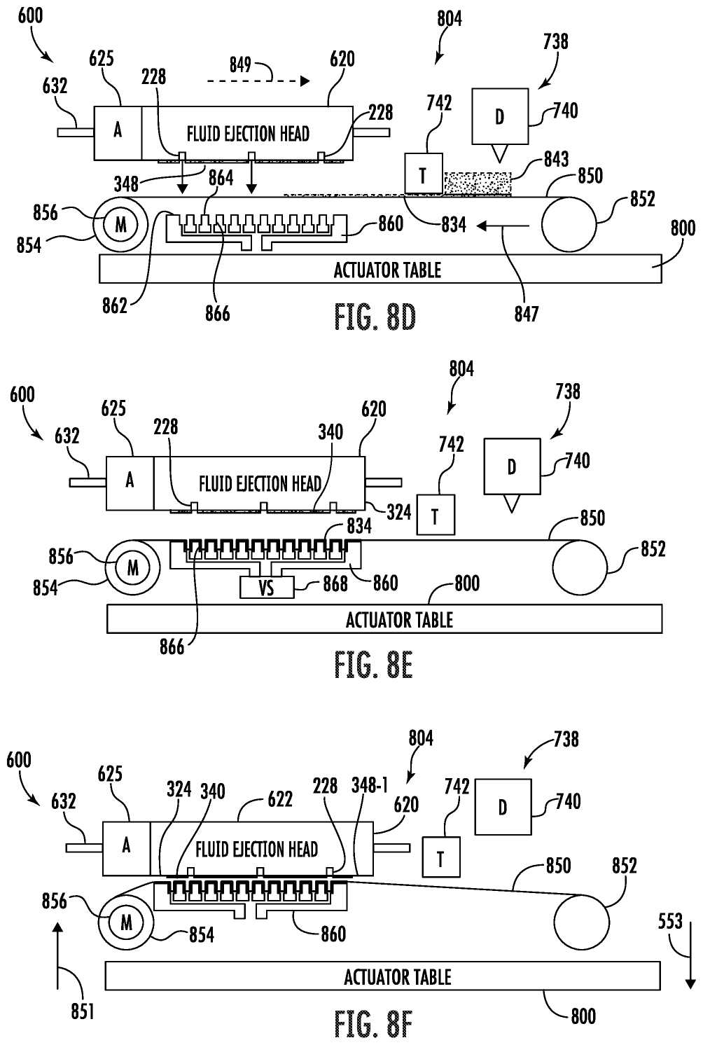

FIGS. 8A-8F are side views illustrating portions of an example fluid ejection system 600. System 600 may carry out the treatment method 100 described above with respect to FIG. 2. System 600 may treat a fluid ejection head to form any of the above described fluid ejection heads 20, 120, 320, 420 and 520. System 600 may periodically refurbish a fluid ejection face with new or additional coated portions 340 and/or 440 during the life of the fluid ejection system following initial use of the fluid ejection system.

As shown by FIGS. 8A, 8B and 8D, fluid ejection system 600 comprises fluid ejection head 620, media supply 624, actuator 625, and service station 630. Media supply 624 supplies a medium 633 (shown in FIG. 8C) for receiving the fluid ejected from fluid ejection head 620. In one implementation, media supply 624 comprise a series of rollers that pick and move sheets of media along a media path, a portion of which is situated opposite to fluid ejection head 620. In another implementation, media supply 624 may comprise a supply roll and a take up roll for supporting a web of the medium that is to receive fluid ejected from fluid ejection head 620.

Fluid ejection head 620 is movably supported along a guide 632 for movement between a fluid ejection or printing position opposite to media supply 624 and a servicing position opposite to service station 630. In one implementation, guide 632 comprises a guide rod along which fluid ejection head 620 slides. In other implementations, fluid ejection head 620 is movably supported for movement between media supply 624 and service station 630 in other manners. For instance, in some cases, service station 630 may be moved into position relative to fluid ejection head 620.

Actuator 625 comprises a device operably coupled to fluid ejection head 620 so as to translate fluid ejection head 620 along guide 632 between the fluid ejection position and the servicing position. In one implementation, actuator 625 comprises a carriage supporting fluid ejection head 620. In one implementation, actuator 625 comprises a motor that drives a flexible cable about a pair of pulleys or guides and along guide 632, wherein a portion of the flexible cable is attached to the carriage, supporting fluid ejection head 620, and wherein the motor controllably drives the cable to translate fluid ejection head 620 along guide 632.

FIG. 8A illustrates the positioning of fluid ejection head 620 opposite to media supply 624 by actuator 625. In this position, fluid ejection head 620 ejects fluid through orifices 228 (shown in FIG. 8B) onto a print medium supported by media supply 624. In the example illustrated, fluid ejection face 324 of fluid ejection head 620 comprises previously applied coated portions 340.

Service station 630 carries out various servicing operations on fluid ejection head 620. Service station 630 comprises actuator table 800, purging and wiping station 802 and selective coating station 804. Actuator table 800 comprises a movable platform supporting stations 802 and 804. Actuator table 800 incorporates actuators to move stations 802 and 804 in multiple directions so as to selectively move stations 802 and 804 relative to fluid ejection head 620. In one implementation, actuator table 800 may utilize motors, hydraulic or pneumatic piston-cylinder assemblies or electric motors to move the platform supporting stations 802 and 804.

As shown by FIG. 8B, purging and wiping station 802 comprises a web 806 of a fluid absorbent material provided and supported by a supply roll 808 and a take-up roll 810 which is rotatably driven by a motor 812. Rolls 808 and 810 support a span of web 806 for receiving fluid being purged or spit from fluid ejection head 620 through orifices 228.

Purging and wiping station further includes a wiper 813 and a pair of rollers 814. Web 806 is guided by rollers 814 and wraps about wiper 813 between rolls 808, 810. Wiper 813 presses a portion of web 806 into contact with fluid ejection face 324 to wipe fluid ejection face 324 as fluid ejection head 620 and/or web 806 are transversely moved relative to one another. For example, in one implementation, web 806 may be pulled in the direction indicated by arrow 851 by the winding of the web 806 about take up roll 810 by motor 812. Movement of web 806 over wiper 813 to and against fluid ejection face 324 wipes fluid ejection face 324. In some implementations, fluid ejection head 620 may be additionally moved in the direction indicated by arrow 853 relative to web 806 to facilitate such wiping.

In some implementations, wiper 813 is stationary. In other implementations, wiper 813 may be vertically movable to raise and lower portions of web 806 into and out of contact with fluid ejection face 324. In yet other implementations, wiper 813 may be a rubber or elastomeric wiper blade supported independent of web 806, such as to a side of web 806, so as to directly contact and wipe fluid ejection face 324 during a wiping service operation.

FIG. 8B illustrates the servicing of fluid ejection head 620. FIG. 8B illustrates fluid ejection head 620 after head 620 has been moved by actuator 625 along guide 632 to a position (shown in broken lines in FIG. 8A) directly opposite to purging and wiping station 502. FIG. 8B further illustrates the purging or spitting of fluid through orifices 228 onto the absorbent web 806 to clear orifices 228. FIG. 8B further illustrates wiper 813 pressing portions of web 806 into contact with fluid ejection face 324. In the example illustrated, the entire actuator table 800 is lifted to thereby lift wiper 813. In other implementations, wiper 813 may be lifted relative to actuator 500 to move portions of web 806 into wiping contact with fluid ejection face 324. While portions web 806 are being pressed against fluid ejection face 324 by wiper 813, fluid ejection head 620 and/or portions web 806 are moved relative to one another. In one implementation, motor 812 rotates take-up roll 810 to advance web 806 in the direction indicated by arrow 851 over wiper 813 and against fluid ejection face 324 to wiper fluid ejection face 324. In another implementation, actuator 625 further moves fluid ejection head 620 in the direction indicated by arrow 553 relative to wiper 813 such that portions web 806 are wiped against fluid ejection face 324. In yet other implementations, web 806 may be driven in the direction indicated by arrow 851 while fluid ejection head 620 is also moved in the direction indicated by arrow 853 to carry out wiping a fluid ejection face 324.

Selective coating station 804 selectively applies a layer of a non-wetting material to selected portions fluid ejection face 324. Station 804 comprises a wound web 850 supported by supply roll 852 (see, e.g., FIG. 8D et seq.), take-up roll 854 which is rotatably driven by a rotary actuator in the form of a motor 856, serving as a web drive, and vacuum chuck 860.

Applicator 738 comprises dispenser 740 and thinner 742. Dispenser 740 comprises a device that deposits a mass or dose of non-wetting material onto a portion of web 850. In one implementation, dispenser 740 may comprise a reservoir and a valve that is selectively opened and closed so as to permit the flow of the non-wetting material onto web 850. In yet another implementation, dispenser 740 may comprise a jetting or spraying apparatus to control the deposition of the non-wetting material on web 850. In one implementation, the dose of the deposited non-wetting material has a thickness greater than the controlled thickness provided by thinner 842.

Thinner 742 controls the thickness of the non-wetting material on web 850 to form the non-wetting layer 834. For purposes of illustration, the relative thickness of the layer of material corresponding to portion 340 and thickness of the non-wetting layer 834 is exaggerated. In one implementation, thinner 742 comprises a doctor blade. In another implementation, thinner 742 comprises a roller. The thickness of layer 834 is controlled such that layer 834, when stamped against fluid ejection face 324, does not fill or enter orifices 228. In one implementation, applicator 738 provides the non-wetting layer 834 with a thickness of no greater than 3 μm. In one implementation, applicator 538 provides the non-wetting layer 834 with a thickness of no greater than 1 μm. In one implementation, the non-wetting layer 834 has a thickness of no greater than 100 Å. In one implementation, applicator 738 provides a non-wetting layer 834 having a thickness of no greater than 1/10 of an average diameter of the orifices 228. In one implementation in which the orifice openings have an average diameter of 25 μm, applicator 738 provides layer 834 with the controlled thickness of no greater than 1 μm.

Vacuum chuck 860 comprises a member underlying portions of web 850 and having a face 862 that is to be raised so as to press overlying portions of web 850 towards and into close proximity with fluid ejection face 324 of fluid ejection head 620 so as to stamp portions of layer 834 on web 850 against selected portions of fluid ejection face 324. Face 862 comprises raised portions 864 and vacuum recesses 866, wherein the raised portions 864 correspond to regions of fluid ejection face 324 where portions of layer 834 are to be stamped to form coated portions 340. In the example illustrated, the raised portions 864 have shapes and sizes corresponding to the coated portions 340 shown in FIG. 5. In other implementations, the raised portions 864 may have other patterns and shapes depending upon the pattern and shape of coated portions 340 to be stamped on fluid ejection face 324.

Vacuum recesses 866 correspond to regions of fluid ejection face 324 which are to remain uncoated with layer 834 during the stamping a fluid ejection face 324. Vacuum recesses 866 are pneumatically connected to a vacuum source 868 (shown in FIG. 8E) which, as will be described hereafter, draws portions of web 850 into such vacuum recesses such that web 50 has a surface contour corresponding to the contour of face 862.

FIG. 8C illustrates the positioning of fluid ejection head 620 opposite to selective coating station 804. In the example illustrated, actuator table 800 is driven in the direction indicated by arrow 855 to locate fluid ejection head 620 over web 850. FIG. 8D illustrates the coating of substrate web 850 with a layer 834 of non-wetting material 843, wherein the layer 834 has a controlled thickness. In the example illustrated, dispenser 740 deposits the dose of non-wetting material 843 on a first side of thinner 742 and motor 856 drives take-up roll 854 to advance web 850 in the direction indicated by arrow 847. The thicker mass of non-wetting material 843 on a first side of thinner 742 is thinned to the controlled thickness of layer 834 on a second opposite side of thinner 742. As shown by FIG. 8E, motor 856 continues to advance web 850 and the carried layer 834 of non-wetting material to a position over vacuum chuck 860 and opposite to fluid ejection face 324 of fluid ejection head 620. In some implementations, such positioning may be further facilitated by movement of fluid ejection head 620 by actuator 625 in the direction indicated by arrow 849 (shown in FIG. 8D).

As shown by FIG. 8E, vacuum source 868 is actuated to apply a vacuum to recesses 866, drawing those portions web 850 over such recesses 866 into recesses 866. Selected portions of layer 834 are drawn into recesses 866 so as to not contact fluid ejection face 324 during stamping of fluid ejection face 324 shown in FIG. 8F. As a result, layer 834 contains a surface profile of raised portions and depressions corresponding to the raised portions and vacuum recesses of vacuum chuck 860, wherein the raised portions formed in layer 834 correspond to coated portions 340 of head 620.

As shown by FIG. 8F, following the positioning of layer 834 and fluid ejection face 324 opposite to one another and the application of the vacuum by vacuum source 868, actuator table 800 is lifted in the direction indicated by arrow 851 to raise the raised portions of layer 834 into contact with fluid ejection face 324 and any prior coated portions 340 on fluid ejection face 324 without wiping of fluid ejection face 324 or layer 348-1. As a result, portions of layer 834 become stamped onto fluid ejection face 324 to add additional non-wetting material to fluid ejection face 324.

Following such stamping, actuator table 800 may be lowered in the direction indicated by arrow 853 and fluid ejection head 620 may once again be moved by actuator 625 to the position shown in FIG. 8A opposite to a print medium supported by media supply 624, ready for ejecting fluid onto the print medium supported by media supply 624. The formed layer 834 and vacuum chuck 860 may be used for successive stampings of fluid ejection face 324 until the material of layer 834 has been sufficiently depleted. At such point in time, the different portion of web 850 may receive a new layer 834 as shown in FIG. 8D and web 850 may be advanced by motor 856 to position the new portion of web 850 and its new layer 834 over and opposite to vacuum chuck 860 for subsequent treatments of fluid ejection head 620 as shown in FIG. 8E.

Although system 600 is illustrated as having a single selective coating station 804, in other implementations, system 600 may include additional selective coating stations for applying other coating materials having other coating layouts or patterns to fluid ejection face of a fluid ejection head. For example, system 600 may comprise an additional selective coating station having an additional separate dispenser, thinner, web, web drive and vacuum chuck for additionally applying coating portion 440 with a different coating material as described above with respect to FIG. 6.

Although selective coating station 804 is described for use in retreating or refurbishing selected portions of the fluid ejection face 324 with a coating to reduce fluid puddling, selective coating station 804 may likewise be provided or used without the remaining portions of system 600. For example, selective coating station 804 described above may be independently used to selectively apply a coating to selected portions of the fluid ejection face prior to shipping of the fluid ejection head or the associated fluid ejection system to reduce shipping tape removal damage as described above. In one implementation, prior to the application of shipping tape to a fluid ejection head, the fluid ejection head may be positioned opposite to multiple different selective coating stations 804, wherein a first selective coating station 804 selectively applies a coating material to form coating portions 540-1 and 540-2, wherein a second selective coating station 804 selectively applies a coating material to form coating portions 540-3, wherein a third selective coating station 804 selectively applies a coating material to form coating portions 540-4 and wherein a fourth selective coating station 804 selectively applies a coating material to form coating portions 540-5, each of such portion being described above with respect to fluid ejection head 520 in FIG. 7.

Although the present disclosure has been described with reference to example implementations, workers skilled in the art will recognize that changes may be made in form and detail without departing from disclosure. For example, although different example implementations may have been described as including features providing various benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. A fluid ejection head comprising:
a fluid ejection face through which fluid ejection orifices extend; and
a coating selectively coated over first portions of the fluid ejection face, second portions of the fluid ejection face omitting the coating.

2. The fluid ejection head of claim 1 further comprising shipping tape across and over the fluid ejection face, the shipping tape adhered to the ejection face with an adhesive having a first adhesive strength, wherein the coating has a second adhesive strength less than the first adhesive strength.

3. The fluid ejection head of claim 2, wherein the first portions of the fluid ejection face having the coating comprise edge portions of the fluid ejection face and wherein the second portions comprise regions encircling each of the fluid ejection orifices.

4. The fluid ejection head of claim 2, wherein the first portions of the fluid ejection face having the coating are spaced from each of the fluid ejection orifices by 2 mm or greater than 2 mm.

5. The fluid ejection head of claim 1, wherein the coating comprises a non-wetting material adjacent to and about the fluid ejection orifices.

6. The fluid ejection head of claim 1, wherein the coating comprises a first portion comprising a non-wetting material adjacent to and about the fluid ejection orifices and a second portion comprising a wetting material.

7. The fluid ejection head of claim 1, wherein the fluid ejection orifices comprise first orifices to eject a first fluid having first characteristics and second orifices to eject a second different fluid having second characteristics different than the first characteristics, the coating comprising a first material adjacent to and about the first orifices and a second material different than the first material adjacent to and about the second orifices.

8. A fluid ejection head treatment method comprising:
selectively applying a coating to first portions a fluid ejection face of a fluid ejection head; and
selectively omitting the coating from second portions of the fluid ejection face.

9. The method of claim 8, wherein the selective applying of the coating to the first portions comprises stamping the coating onto the first portions of the fluid ejection face of the fluid ejection head.

10. The method of claim 9, wherein the selective applying of the coating to the first portions comprises:
applying the coating to a film;
positioning the film with the coating over a vacuum chuck having raised portions and vacuum recesses, the vacuum recesses corresponding to the second portions of the fluid ejection face;
applying a vacuum to the vacuum chuck to draw first portions of the film into the vacuum recesses; and
positioning second portions of the film supporting the coating and supported by the raised portions into proximity with the fluid ejection face to transfer the coating to the first portions of the fluid ejection face.

11. The method of claim 8 further adhering a shipping tape carrying an adhesive to the fluid ejection head over the fluid ejection face, wherein the adhesive has a first adhesive strength and wherein the coating has a second adhesive strength less than the first adhesive strength.

12. The method of claim 11, wherein the first portions of the fluid ejection face having the coating comprise edge portions of the fluid ejection face and wherein the second portions comprise a region surrounding a fluid ejection orifice of the fluid ejection face.

13. The method of claim 8 further comprising ejecting fluid through fluid ejection orifices of the fluid ejection face, wherein the selective applying of the coating follows the ejecting of the fluid through the fluid ejection orifices.

14. A fluid ejection head selective coating station comprising:
a film;
a vacuum chuck having raised portions and vacuum recesses, the vacuum recesses corresponding to portions of the fluid ejection face which are not to be selectively coated by the system;
an applicator to apply a coating to the film;
a vacuum source connected to the vacuum chuck to draw first portions of the film, coated with the coating, into the vacuum recesses; and
an actuator to move a fluid ejection head and the vacuum chuck into proximity so as to transfer the coating onto a fluid ejection face of the fluid ejection head.

15. The station of claim 14 further comprising:
a wound web providing the film; and
a rotary actuator coupled to the wound web to selectively advance the wound web relative to the vacuum chuck.
